(19) United States
(12) Patent Application Publication
(10) Pub. No.: US 2025/0153984 A1
(43) Pub. Date: May 15, 2025

(54) DETACHABLE LIFT ASSEMBLY

(71) Applicant: KENNETH EDWARDS, BROUSSARD, LA (US)

(72) Inventor: KENNETH EDWARDS, BROUSSARD, LA (US)

(21) Appl. No.: 18/948,273

(22) Filed: Nov. 14, 2024

Related U.S. Application Data
(60) Provisional application No. 63/598,814, filed on Nov. 14, 2023.

(51) Int. Cl. B66F 5/02

(52) U.S. Cl. CPC B66F 5/02

(57) ABSTRACT

A lift assembly for use with automobiles includes a tire lift and a detachable lift. The tire lift is configured to grasp and selectively lift a tire while the detachable lift is selectively configured to locate and lift up the automobile using a jack. The tire lift and the detachable lift transfer data between them and include a battery supply and motor controller. The motor controller operates motors used to selectively locate the detachable lift relative to the tire lift. A sliding body adapter is coupled to the tire lift and is configured to translate along a plane relative to the tire lift. A body extender is coupled to the detachable lift and configured to translate so as to locate the jack. The body extender is configured to move the jack in a direction perpendicular to that of the movement of the sliding body adapter.

### CROSS REFERENCE TO RELATED APPLICATIONS

This application claims the benefit of an earlier filing date and right of priority to U.S. Provisional Application No. 63/598,814, filed 14 Nov. 2023, the contents of which is incorporated by reference herein in its entirety.

### BACKGROUND OF THE INVENTION

### 1. Field of the Invention

The present application relates to an automotive jack, and more particularly to a powered jack for raising and lowering a vehicle.

### 2. Description of Related Art

The process of replacing tires on vehicles has undergone significant advancements. In the early days of automobile technology, tires were predominantly made of solid rubber, requiring laborious manual effort for removal and replacement. As automotive technology evolved, pneumatic tires with inflatable inner tubes became the standard, providing improved comfort and performance. However, changing these tires still involved substantial physical exertion, often necessitating the use of hand tools and jacks.

In more recent times, the introduction of automated tire-changing machines and hydraulic lifts revolutionized the tire replacement process. These innovations significantly reduced the physical labor required and enhanced efficiency in tire service. Today, with the aid of advanced tools and equipment, the tire replacement process continues to be refined. Modern solutions leverage cutting-edge technologies to streamline and simplify the task, aiming to minimize manual effort, increase safety, and improve overall efficiency. The history of tire replacement showcases a constant drive for innovation and improvement, with a focus on reducing labor, enhancing convenience, and maximizing the effectiveness of tire servicing operations.

The current process of replacing tires on vehicles poses several challenges that impact efficiency, safety, and labor requirements. Firstly, the manual labor involved in tire replacement can be physically demanding and time-consuming. Technicians often need to exert considerable effort to remove heavy wheels and tires, leading to fatigue and potential injuries. Additionally, the process may require multiple tools and equipment, further complicating the task and increasing the risk of errors or accidents.

Furthermore, the traditional methods of tire replacement lack automation and advanced technology, resulting in inefficiencies. Manual jacking and positioning of vehicles can be imprecise and time-consuming, causing delays in the overall service process. The absence of automated controls and wireless communication adds to the complexity and potential for human error. Additionally, the current process does not fully utilize modern advancements such as remote-control operation or Bluetooth connectivity, missing opportunities for improved convenience and efficiency. Although strides have been made, shortcomings remain.

### BRIEF SUMMARY OF THE INVENTION

It is an object of the present application to provide an assembly configured to facilitate both the ability to jack up an automobile and to assist in removing a tire from the same automobile. The invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a detachable lift engaged with a vehicle according to an embodiment of the present application.

FIG. 2 is an upper perspective view of the detachable lift of FIG. 1 in communication with a tire lift.

FIGS. 3 and 4 are upper perspective views of the detachable lift of FIG. 2 indifferent positions related to the tire lift.

FIG. 5 is a bottom view of the detachable lift of FIG. 2 with the tire lift.

FIG. 6 is an enlarged lower perspective view of the detachable lift of FIG. 2 relative to the tire lift.

FIG. 7 is an enlarged upper perspective view of the detachable lift of FIG. 2 adjacent to the tire lift.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein, like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

The detachable lift of the present application is configured to revolutionize the process of removing tires and wheels from vehicles. Traditionally, this task involves significant manual labor, but the detachable lift, in combination with the tire lift or mechanical tire lift, aims to reduce the effort required. The detachable lift consists of a power telescoping jack that attaches to the base plate of the tire lift, enabling easy positioning of the jack under the vehicle. Equipped with omnidirectional casters, the detachable lift allows precise movement and positioning, powered by an automatic connect and disconnect system from the tire lift.

With the detachable lift engaged, the vehicle can be safely lifted to a convenient working height, while the tire lift remains in place to facilitate the removal of the wheel/tire assembly. The combination of the tire lift and detachable lift significantly reduces labor and time required for servicing vehicles. The wireless remote control or Bluetooth phone app provides convenient operation, and all movement functions are powered, eliminating the need for manual effort. Moreover, the detachable nature of the detachable lift allows it to be utilized separately and stored independently, adding to its versatility and effectiveness. By enhancing efficiency, reducing labor, and increasing the safety of shop personnel, the detachable lift revolutionizes the tire and wheel removal process.

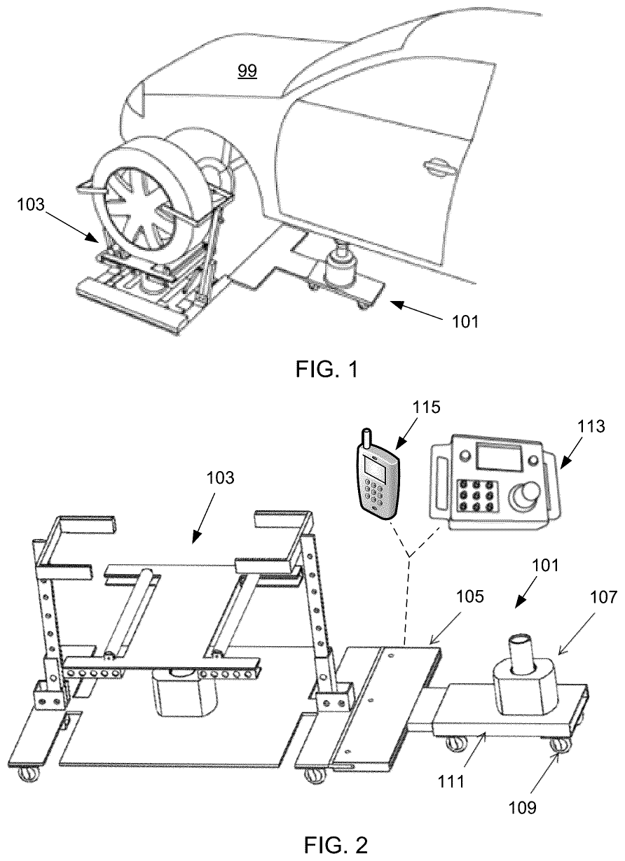

Referring now to FIG. 1 in the drawings, an upper perspective view of a detachable lift 101 is illustrated. Detachable lift 101 is configured to be selectively located below a portion of vehicle 99. Detachable lift 101 is configured to selectively engage a jack to a lower surface of vehicle 99 to induce an upward lifting motion. Detachable lift 101 is selectively engaged with a tire lift 103. Detachable lift 101 and tire lift 103 are in selective communication such that each may be detachable from the other. It is also understood that each lift 101 and 103 may communicate relative to one another so as to convey and receive operative commands. Usage of detachable lift 101 permits a user to avoid the extreme physical labor and additional tools necessary to change a tire.

Referring now also to FIG. 2 in the drawings, and upper perspective view of detachable lift 101 and tire lift 103 are illustrated. In FIG. 2, vehicle 99 and the tire of vehicle 99 are removed for clarity. Detachable lift 101 includes A sliding body adapter 105 which is configured to engage and disengage from the tire lift 103. Electrical communications and power may be routed through connection points there between the lifts. Also included is a powered piston jack 107. Jack 107 is configured to be a compact lift that allows for easy clearance and less manual labor such that no manual jacking of vehicle 99 is required. Power for jack 107 may be provided from tire lift 103 or from components within detachable lift 101 via a battery supply. Detachable lift 101 is configured to include a plurality of casters or wheels 109. Wheels 109 are ideally omni-directional wheels that permit smooth and incremental movements in any direction along a singular plane. A body extender 111 is in communication with body adapter 105 and is configured to selectively extend and retract so as to adequately position jack 107 in a first direction.

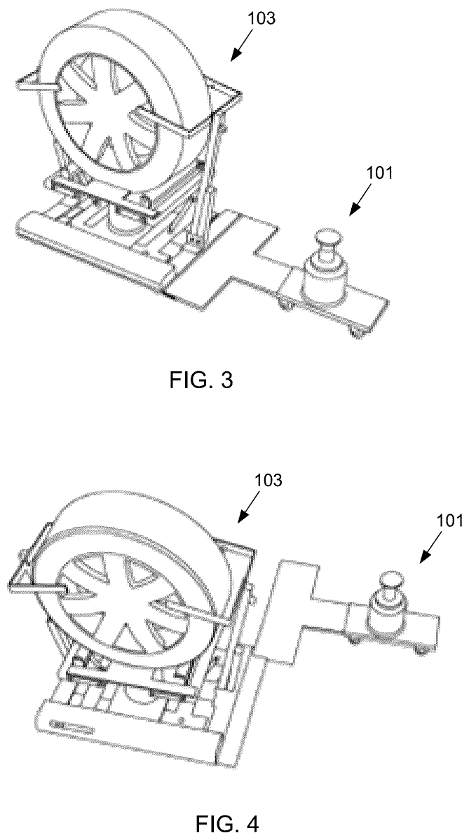

Referring now also to FIGS. 3 and 4 in the drawings, upper perspective views of detachable lift 101 and tire lift 103 are provided. It is understood that detachable lift 101 may be operable without the use of tire lift 103. Detachable lift 101 may be located by aligning jack 107 to an appropriate position on vehicle 99 by positioning and moving wheels 109 along the ground. FIGS. 3 and 4 in the drawing illustrate different positions of detachable lift 101 relative to tire lift 103. In FIG. 3, detachable lift 101 is fully engaged and seated with that of tire lift 103. In FIG. 4, tire lift 103 and detachable lift 101 have moved horizontally relative to one another and are only partially connected. It is understood that both lifts 101 and 103 may be fully detached and or partially detached depending on environmental conditions and need. The connection between detachable lift 101 and tire lift 103 is that of a premanufactured groove and key wherein translation between the two lifts may be done in at least one and perhaps 2 different directions. Electrical connections between the two lifts are maintained unless fully detached from each other. Body extender 111 is configured to translate the jack in a direction perpendicular to that of the movement of body adapter 105.

Referring back to FIG. 2 in the drawings detachable lift 101 is operable with a remote operating device such as a remote controller 113 and or also a cellular phone 115. Controller 113 and phone 115 are configured to provide operable controlled data to either or both of detachable lift 101 and tire lift 103. So long as detachable lift 101 is in communication with tire lift 103 electrical communication occurs. Controller 113 and phone 115 are input devices configured to relay command data to engage one or more functional operations of lifts 101 and 103. Such command data may include positional functions of jack 107 relative to vehicle 99. Additional functional features may include the elevation of jack 107 and the extension of body extender 111. Wheels 109 are configured to swivel 360 degrees and permit maximum maneuverability so as to adequately and correctly locate jack relative to vehicle 99.

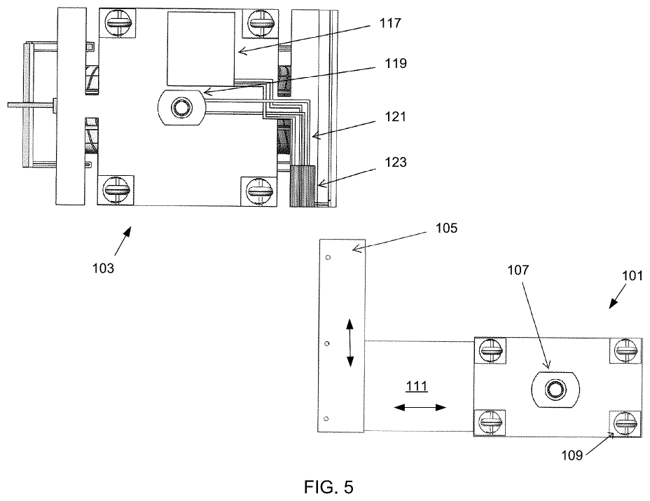

Referring now to FIG. 5 in the drawings, a bottom view of tire lift 103 and detachable lift 101 is provided. In this view both lifts are fully detached from one another. A lower portion of body adapter 105 is shown along with extender 111 and wheels 109. Electrical components of tire lift 103 are illustrated in this view. A battery supply 117 is located along a lower surface and is configured to provide power to tire jack 119. Jack 119 is similar in form and function to that of Jack 107. Both jacks are telescoping piston jacks. Jack 119 is configured to selectively raise and lower a tire assembly to assist in removal of the tire from vehicle 99. Also included is circuitry 121 which may include power supply and additional Bluetooth data communications configured to provide power, ground, and phase to the one or more motors. Motor controller 123 is configured to directly control and regulate the position of jack 119. Circuitry 121 is communicable with that of detachable lift 101 through the premanufactured key and groove.

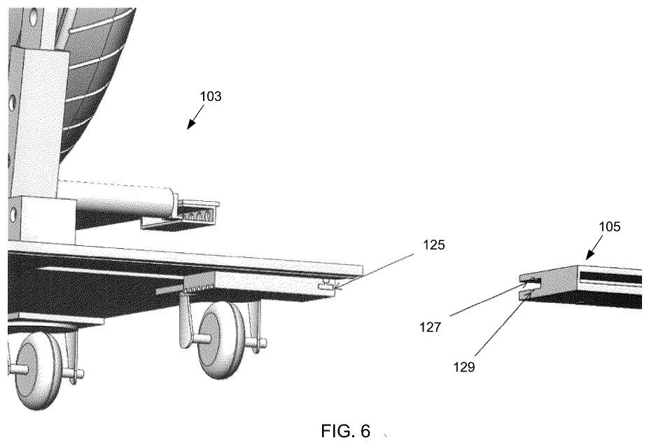

Referring now also to FIG. 6 in the drawings, an enlarged lower perspective view of tire lift 103 and detachable lift 101 are illustrated. In this view the key and groove connection between the lifts are more clearly shown. A negative terminal 125 is located toward a corner or edge of tire lift 103. The groove associated with adapter 105 is shown. The positive power supply 127 is configured to contact circuitry 121. A negative ground 129 is routed to jack 107 from circuitry 121. The location of turn negative terminal 125 and circuitry 121 in general permits the relative translation of detachable lift one-on-one relative to tire lift 103. Adapter 105 is configured to transmit data between the two lifts so long as a portion of the premanufactured groove and key are in connection with each other. This allows detachable lift 101 to translate under vehicle 99 to a desired location. Extender 111 is configured to selectively translate Jack perpendicular to that of the motion of adapter 105. Thereby jack 107 may be located at any point along an XY plane.

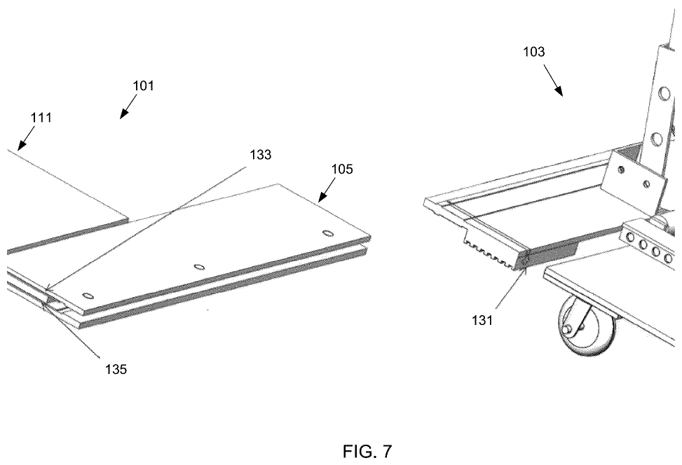

Referring now also to FIG. 7 in the drawings, an upper rear perspective view of detachable lift 101 and tire lift 103 is illustrated. In this view the lifts are detached similarly to that of FIG. 6. A positive power terminal connection 131 is exemplary located on tire lift 103. A positive power supply 133 is located within adapter 105 and is used to supply power to jack 107. A negative ground 135 is also shown providing a ground to jack 107. It is to be understood that the circuitry 121 illustrated in the associated drawings are exemplary in nature. It is understood that various components and circuitry may be routed in different ways. This description and illustration serve as a representation of only one way of routing circuitry 121 between the lifts.

In operation, once the power jack 107 is engaged and lifts the vehicle 99 to a working position, the tire lift 103 is positioned to remove the wheel/tire assembly. The combination of the tire lift 107 and the detachable lift 101 as an all-in-one unit will reduce the amount of labor required to service the vehicle. The amount of time and energy the combination of the tire lift 103 and the detachable lift 101 is considerable. The unit will increase the safety of personnel involved in the service and the time required for the service. The detachable lift 101 can be removed from the tire lift 103 unit, utilized, and stored separately. With the advent of Bluetooth technology and the remote control, the manual labor involved is reduced significantly, and the detachable lift 101 will complete the effectiveness of the entire unit.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A lift assembly, comprising:
a detachable lift having a jack;
a tire lift in detachable communication with the detachable lift;
a sliding body adapter coupled to the tire lift, the sliding body adapter including a groove and a corresponding key on the tire lift, the sliding body adapter configured to translate along a plane relative to the tire lift; and
a body extender coupled to the detachable lift, the body extender configured to translate so as to locate the jack, the body extender configured to move the jack in a direction perpendicular to that of the movement of the sliding body adapter, movement of the sliding body adapter and the body extender operate together to locate the jack.

2. The assembly of claim 1, wherein the tire lift if configured to selectively actuate to lift a tire.

3. The assembly of claim 1, wherein the detachable lift is configured to raise and lower the jack.

4. The assembly of claim 1, wherein the detachable lift further includes a plurality of caster wheels.

5. The assembly of claim 1, further comprising:
a battery supply in communication with the tire lift and the detachable lift.

6. The assembly of claim 1, further comprising:
a motor controller and a motor to regulate the position and movement of the sliding body adapter and the body extender.

7. The assembly of claim 6, wherein the tire lift includes a controller configured to regulate the motor controller and the motor.

8. The assembly of claim 1, further comprising:
a remote operating device.

9. A lift assembly, comprising:
a detachable lift having a jack;
a tire lift in detachable communication with the detachable lift;
a sliding body adapter coupled to the tire lift, the sliding body adapter including a groove and a corresponding key on the tire lift, the sliding body adapter configured to translate along a plane relative to the tire lift;
a body extender coupled to the detachable lift, the body extender configured to translate so as to locate the jack, the body extender configured to move the jack in a direction perpendicular to that of the movement of the sliding body adapter, movement of the sliding body adapter and the body extender operate together to locate the jack;
a battery supply in communication with the tire lift and the detachable lift; and
a motor controller and a motor to regulate the position and movement of the sliding body adapter and the body extender.

10. The assembly of claim 9, wherein the tire lift if configured to selectively actuate to lift a tire.

11. The assembly of claim 9, wherein the detachable lift is configured to raise and lower the jack.

12. The assembly of claim 9, wherein the detachable lift further includes a plurality of caster wheels.

13. The assembly of claim 9, further comprising:
a remote operating device.
